(19) United States
(12) Patent Application Publication
(10) Pub. No.: US 2007/0223035 A1
(43) Pub. Date: Sep. 27, 2007

(54) Image Forming System and Control Method Thereof

(75) Inventor: Toshihiko Murakami, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/277,476

(22) Filed: Mar. 24, 2006

(51) Int. Cl. G06F 3/12; G06F 15/00

(52) U.S. Cl. 358/1.16; 358/1.15; 358/426.06

(57) ABSTRACT

The invention provides an image forming system including a plurality of image forming apparatuses and a storage device to be connected thereto, and a method of controlling the same, and the image forming apparatuses and the storage device are connected to each other through a dedicated interface.

### BACKGROUND OF THE INVENTION

1. Field of the Invention

The present invention relates to an image forming system comprising a plurality of image forming apparatuses and a storage device to be connected thereto, and a method of controlling the same.

2. Description of the Related Art

An image forming apparatus having copy and printer functions (which will be hereinafter referred to as an MFP) has the function of sequentially printing image data on a page unit, that is, printing an image scanned by an image reading apparatus every page, interpreting page data such as characters, lines or photographic images expressed in a page description language by an RIP (Raster Image Processor) function through a printer driver, converting the data into a raster image formed by a line and printing an image developed into the page data.

The MFP is to have a storage function in order to store the page data until a print job is completed. The reason is as follows.

1) In the middle of the print job, a series of page data are stored to prepare for the case in which troubles such as paper clogging are made so that printed page data are required again.

2) In the case in which a plurality of copies is to be printed in order of a page, printed page data for a first copy are stored to prepare for printing for second and succeeding copies.

3) In the case in which additional functions such as a two-side printing function, a two-in-one function and a magazine sort function of the MFP are utilized, all pages are once stored.

As a storage device, an HDD device is often used in respect of a capacity. Since the HDD device is a nonvolatile or permanent retention type storage device and can hold data even if a power supply of the MFP itself is turned OFF, it is also suitable for the retention of scan data or the retention of templates which is another function of the MFP (for example, JP-A-2000-341452).

In the case in which print page data are temporarily stored, it is necessary to once retain all of the page data of a print job in the storage device. Even if a large number of jobs are related to printing for a small number of pages, therefore, it is necessary to have a storage capacity corresponding to a maximum number of copy (or print) enable pages in the MFP.

For one MFP, consequently, a storage device having an excessively large capacity is to be provided or a user has to give up printing for a specific large job. Also in an HDD device having a comparatively large capacity, a waste caused by a difference between a normal use capacity and an absolute capacity is not eliminated.

Referring to an MFP which can be utilized by a large number of unspecified users in an office, furthermore, a problem of a security has recently been pointed out. In the case in which the HDD device to be the nonvolatile storage device is put in the vicinity of a place in which the MFP is disposed, there is a fear that image data might leak out due to a physical steal of the HDD device.

### BRIEF SUMMARY OF THE INVENTION

According to embodiments of the present invention, it is an object to provide an image forming system comprising a plurality of image forming apparatuses and a storage device to be connected thereto, and a method of controlling the same.

The present invention may provide an image forming system comprising:

1) the image forming apparatuses (MFPs);

2) the storage device including an interface device, at least one HDD and a control device;

the interface device having a plurality of connecting terminals capable of connecting the storage device to the MFPs,

the HDD being divided into a plurality of partitions and each of the partitions being caused to correspond to each of the HFPs to be connected, and

the control device receiving print data to be transferred from each of the MFPs through the interface device, storing them in the HDD, transferring the print data to the MFP at a request given from the MFP and deleting the print data on the HDD at a request for deleting the print data based on a job completion which is given from the MFP, and

3) a dedicated interface device provided in each of the image forming apparatuses and connected to the interface device on the storage device side.

### DESCRIPTION OF THE DRAWINGS

FIG. 1 is a diagram showing a structure of an image forming system according to an embodiment of the invention.

FIG. 2 is a flowchart showing a flow of a processing of a print job in the image forming system.

### DETAILED DESCRIPTION OF THE INVENTION

Throughout this description, the embodiments and examples shown should be considered as exemplars, rather than limitations on the apparatus and methods of the present invention.

An embodiment of the invention will be described below with reference to the accompanying drawings. In each of the drawings, the same portions have the same reference numerals.

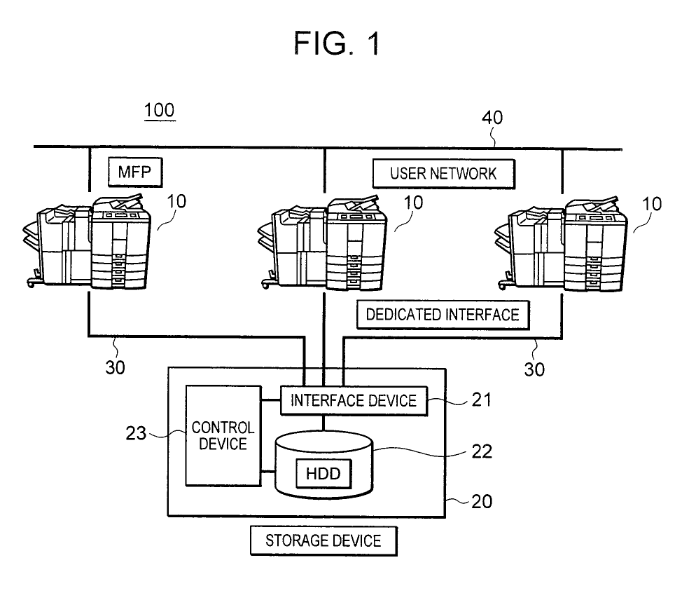

FIG. 1 is a diagram showing a structure of an image forming system according to the embodiment of the invention. An image forming system 100 comprises a plurality of image forming apparatuses (MFPs) 10 such as copying machines, a storage device 20 and a dedicated interface device 30. The MFP 10 basically includes an image processing portion, an image writing portion, an image forming portion, a paper feeding cassette, paper feeding means, a delivery portion, a transfer and separating portion, a fixing device, paper discharging means and a control portion.

Moreover, an image reading mechanism device constituted by an automatic document feeding mechanism and a document image scanning and exposing system is disposed and an operating portion is provided on the MFP 10. The operating portion includes a punch key for specifying a paper perforating mode, a display panel for a message display, an input key, a ten key, a clear key for the ten key, a reset key, a stop key and a start key, for example. A user can specify various modes, the number of copy sheets and a perforation processing by operating the operating portion.

The storage device 20 includes an interface device 21, at least one HDD 22, and a control device 23. The MFP 10 has HDD capacity setting means and one or more partitions in the storage device 20 is/are assigned based on a set capacity.

The interface device 21 has a plurality of connecting terminals through which the storage device 20 can be connected to a plurality of MFPs 10. The HDD 22 is divided into a plurality of partitions and each of the partitions is caused to correspond to each MFP 10 to be connected.

In general, an A4 size, a monochrome image and a bit map have approximately 4 Mbytes. For this reason, it is sufficient that the HDD 22 has a capacity of 100 Gbytes, for example. It is not necessary to cause the number of the partitions to be coincident with that of the MFPs 10 and it is suitable that the number of the partitions should be larger than that of the MFPs 10. Consequently, it is possible to have a spare partition region which does not correspond to the specific MFP 10 and to temporarily assign a spare partition as the region for the MFP if necessary in respect of the operation of each MFP 10. If a disk full state might be brought for an assignment capacity in respect of the operation of each MFP 10, it is possible to avoid the disk full state. By disposing the storage device 20 in a locked special room (server room), it is possible to sufficiently maintain a security.

The control device 23 receives print data transferred from each MFP 10 through the interface device 21 and stores the same print data in the HDD 22. Moreover, the print data are transferred to each MFP 10 at a request given from the MFP 10. Furthermore, the print data on the HDD 22 are deleted at a request for deleting the print data based on a completion of a job which is sent from each MFP 10.

It is suitable that the control device 23 should control to freely give access to only a corresponding partition region for each MFP 10 through the interface device 21 and to conceal partition regions corresponding to the other MFPs 10.

The control device 23 has the function of overwriting and erasing the pertinent region of the HDD 22 in response to a condition set in each MFP 10. The set condition may be set by the user of the MFP 10 or may be preset as a default of the MFP 10. The set condition may include a time interval, for example, an overwrite and erase for each week or a designation of a time zone such as a midnight in which a frequency of use of the MFP 10 is low. The overwriting and erasing method may include a write of random data and an encryption, for example.

The dedicated interface device 30 is provided in each MFP 10, for example, and is connected to the interface device 21 on the storage device 20 side. By using a dedicated interface separated from a basic network, it is possible to eliminate a drawback that an excessive great traffic is caused by sharing the storage device 20 through the MFPs 10. By using the dedicated interface, moreover, it is possible to maintain the degree of freedom for the selection of connectors and cables and the design of a communication protocol in addition to the set of a port.

When starting a setup in a state in which the MFP 10 is connected to the storage device 20 through the dedicated interface device 30, the storage device 20 side specifies and designates the partition region for the MFP 10 which is recognized. Consequently, the specific region of the HDD 22 acts as an internal device (HDD) of the MFP 10. Each MFP 10 may be further connected to a network 40 in a user environment.

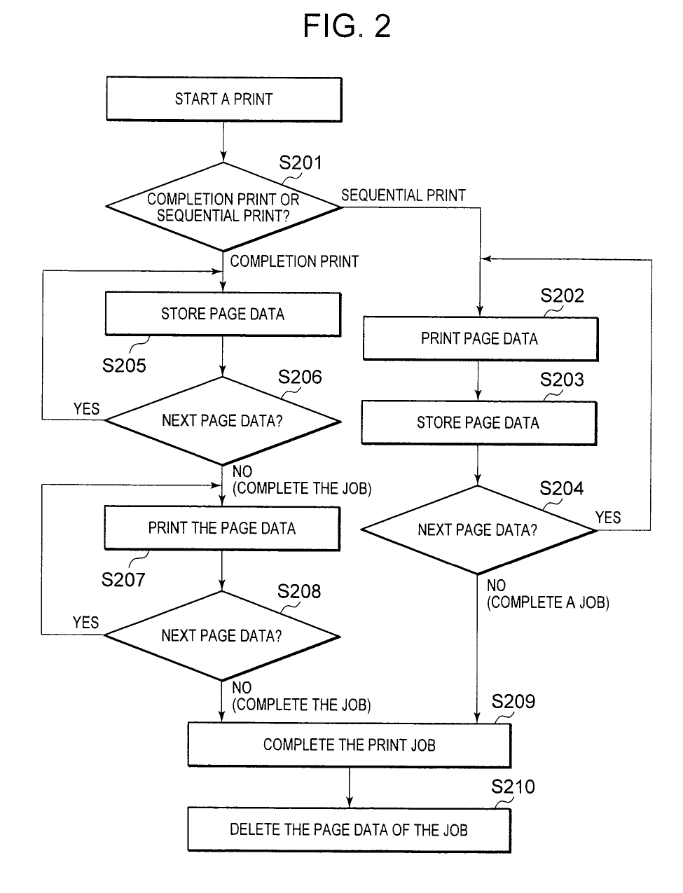

Next, an example of the case of a copy will be described based on a flowchart showing a flow of a processing of a print job in the image forming system illustrated in FIG. 2.

In general, a print mode includes a sequential mode for sequentially printing page data which are read and a completion mode for storing the read page data in the HDD device and starting a print when all of page data of a job are completely stored.

First of all, a print function mode, a completion print or a sequential print is confirmed (Step S201).

In the case of the sequential print, documents set into an automatic document feeding device (ADF) of the MFP are taken out one by one and are sent to the document reading portion. Image data corresponding to one page which are read by the document reading portion pass through the image processing portion so that page data are created.

The page data thus created are sent to a writing device which is not shown and are printed in the image forming portion (Step S202). After the printing operation, the page data are compressed in a predetermined algorithm, and are then transferred to the HDD device and are stored therein (Step S203). The HDD device is a separate device from the MFP through the dedicated interface and is treated as an internal device of the MFP.

Subsequently, the presence of next page data is checked (Step S204). If the next page data are present, the processing returns to the Step S2 and the flow of the sequential print is repeated. If the next page data are not present, the print job is completed (Step S209).

On the other hand, in the case of the completion print, the documents set into the automatic document feeding device (ADF) of the MFP are taken out one by one and are sent to the document reading portion. Image data corresponding to one page which are read by the document reading portion pass through the image processing portion so that page data are created.

The page data thus created are compressed in a predetermined algorithm and are then transferred to the HDD device and are stored therein (Step S205). The HDD device is a separate device from the MFP through the dedicated interface and is treated as an internal device of the MFP.

Subsequently, the presence of next page data is checked (Step S206). If the next page data are present, they are stored in the same manner. If the next page data are not present, the page data which have been stored are sent to the writing device which is not shown and the same page data are printed (Step S207).

Then, the presence of the next page data is checked (Step S208). If the next page data are present, the same processing is carried out and the same page data are then printed (Step S207). If the next page data are not present, the print job is completed (Step S209).

When printing for all of the pages of the print job are completed as described above, the page data which have temporarily been stored on the HDD device are erased (Step S210).

According to the invention, an HDD for storing job data is not provided or an HDD having a large capacity is provided for a plurality of image forming apparatuses (MFPs) including an HDD having a necessary and sufficient capacity for only the number of pages of a normal document, and a complicated job having several ten thousand pages or more can be printed fully, for example. By separating the HDD portion from the MFP body to dispose only the storage device in another locked room (a server management room), for example, it is possible to maintain a physical security (to prevent the HDD from being stolen). Moreover, the storage device corresponds to the MFPs in an office. Therefore, it is possible to carry out a very efficient application. As a result, a system having a high cost performance can be constituted. Furthermore, an interface for connecting the MFP to the storage device has a dedicated interface. For the case in which the network in the user environment is used, therefore, it is possible to prevent an excessively great traffic from being caused over the network, and furthermore, to avoid a risk in respect of a security, that is, a leakage of image data over the network.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming system having a plurality of image forming apparatuses and a storage device to be connected thereto, comprising:
1) the image forming apparatuses (MFPs);
2) the storage device including an interface device, at least one HDD and a control device;
the interface device having a plurality of connecting terminals capable of connecting the storage device to the MFPs,
the HDD being divided into a plurality of partitions and each of the partitions being caused to correspond to each of the MFPs to be connected, and
the control device receiving print data to be transferred from each of the MFPs through the interface device, storing them in the HDD, transferring the print data to the MFP at a request given from the MFP and deleting the print data on the HDD at a request for deleting the print data based on a job completion which is given from the MFP, and
3) a dedicated interface device provided in each of the image forming apparatuses and connected to the interface device on the storage device side.

2. The image forming system of claim 1, wherein the control device controls to freely give access to only a partition region corresponding to each of the MFPs and to conceal partition regions corresponding to the other MFPs.

3. The image forming system of claim 1, wherein the control device has a function of overwriting and erasing a pertinent region of the HDD depending on a condition set in each of the MFPs.

4. The image forming system of claim 3, wherein the set condition can be set by a user of the MFP.

5. The image forming system of claim 3, wherein the set condition is set as a default of the MFP.

6. The image forming system of claim 3, wherein the set condition includes a time interval and a time zone for an overwrite and erase at a time in accordance with the set condition.

7. The image forming system of claim 1, wherein the number of the partitions is larger than that of the MFPs.

8. The image forming system of claim 1, wherein the HDD has a spare partition region which does not correspond to a specific MFP and the control device carries out a control for temporarily assigning the spare partition as the region for the MFP if necessary in respect of an operation of the MFP.

9. The image forming system of claim 1, wherein the MFP is further connected to a network in a user environment.

10. A method for controlling an image forming system in which a plurality of image forming apparatuses and a storage device including at least one HDD are connected to each other through a dedicated interface device comprising:
receiving print data transferred from each of image forming apparatuses (the MFPS);
storing the print data thus received in an HDD corresponding to the MFP connected to each of partitions obtained by a division;
transferring the print data to the MFP at a request given from the MFP; and
deleting the print data on the HDD at a request for deleting the print data based on a job completion which is given from the MFP.

11. The control method of claim 10, wherein only a partition region corresponding to each of the MFPs can be accessed and partition regions corresponding to the other MFPs are concealed.

12. The control method of claim 10, wherein a pertinent region of the HDD is overwritten and erased depending on a condition set in each of the MFPs.

13. The control method of claim 12, wherein the set condition can be set by a user of the MFP.

14. The control method of claim 12, wherein the set condition is set as a default of the MFP.

15. The control method of claim 12, wherein the set condition includes a time interval and a time zone for an overwrite and erase at a time in accordance with the set condition.

16. The control method of claim 10, wherein the number of the partitions is larger than that of the MFPs.

17. The control method of claim 10, wherein the HDD has a spare partition region which does not correspond to a specific MFP and the storage device temporarily assigns the spare partition as the region for the MFP if necessary in respect of an operation of the MFP.

18. The control method of claim 10, wherein the MFP is further connected to a network in a user environment.
